(19) United States
(12) Patent Application Publication
(10) Pub. No.: US 2002/0049627 A1
(43) Pub. Date: Apr. 25, 2002

(54) Data driven entitlement

(76) Inventors: Ravi Goli, San Jose, CA (US); Lavina Nagar, San Jose, CA (US)

Correspondence Address: MCANDREWS HELD & MALLOY, LTD, 500 WEST MADISON STREET, SUITE 3400, CHICAGO, IL, 60661

(21) Appl. No.: 09/837,070

(22) Filed: Apr. 18, 2001

Related U.S. Application Data
(60) Provisional application No. 60/164,021, filed on Aug. 23, 1999.
(60) Provisional application No. 60/243,580, filed on Oct. 25, 2000.
(60) Provisional application No. 60/280,240, filed on Mar. 30, 2001.

(51) Int. Cl. G06F 17/60

(52) U.S. Cl. 705/10

(57) ABSTRACT

A Data Driven Entitlement method and apparatus for providing selective Entitlement to data being accessed by a Partner or an end-user of the system. A User interface collects and maintain certain entitlement information, and a database is used to store the Entitlement information. The Entitlement information is accessed and transformed by a generator into Entitlement Conditions. The Conditions are loaded onto an object cache, and an Entitlement Manager is used for selecting appropriate Conditions from the object cache and appending them in a logical manner. If the Conditions are fulfilled between Partners and/or Users, then Entitlement to the particular data is allowed.

### RELATED APPLICATIONS

This application is related to the following —U.S. Provisional patent application having Ser. No. 60/164,021, entitled “Method and Apparatus to Provide Custom Configurable Business Applications From a Standardized Set of Components,” filed Aug. 23, 1999; Utility patent application having Ser. No. 09/440,326, entitled “Method for Providing Custom Configurable Business Applications from a Standardized Set of Components,” filed Nov. 15, 1999; Utility patent application having Ser. No. 09/439,764, entitled “Apparatus to Provide Custom Configurable Business Applications from a Standardized Set of Components,” filed Nov. 15, 1999; Utility patent application having Ser. No. 09/658,415, entitled “Method For Developing Custom Configurable Business Applications,” filed Sep. 8, 2000; Utility patent application having Ser. No. 09/658,416, entitled “Integrated Design Environment For A Commerce Server System,” filed Sep. 8, 2000; Utility patent application having Ser. No. 09/697,271, entitled “Method for Providing Template Applications For Use By a Plurality of Modules,” filed Oct. 25, 2000; Utility patent application having Ser. No. 09/691,461, entitled “Method and Apparatus for Providing News Client and Server Architecture and Protocols,” filed Oct. 17, 2000; Utility patent application having Ser. No. 09/684,491, entitled “Adapter and Connector Framework for Commerce Server System,” filed Oct. 4, 2000; Utility patent application having Ser. No. 09/702,148, entitled “E-Commerce Application Built Using Workflows on a Workflow Engine and Methods Thereof,” filed Oct. 30, 2000; Utility patent application having Ser. No. 09/702,290, entitled “Presentation Layer For Business Application Development And Methods Thereof,” filed Oct. 30, 2000; Utility patent application having Ser. No. 09/702,291, entitled “Scalability, Availability, and Management Features For Business Commerce Server,” filed Oct. 30, 2000; Utility patent application having Ser. No. 09/706,304, entitled “Content Management Framework For Business Commerce Server,” filed Nov. 3, 2000; Utility patent application having Ser. No. 09/727,912, entitled “Workflow Driven Rules-Based Generation of Personalizable Web Pages,” filed Nov. 28, 2000; Utility patent application having Ser. No. 09/658,416, entitled “Integrated Design Environment for a Commerce Server System,” filed Sep. 8, 2000; and Provisional patent application having Ser. No. 60/243,580, entitled “Globalization Services for Business Commerce Server,” filed Oct. 25, 2000—each of which are hereby incorporated by reference in their entirety.

This application claims priority to Provisional patent application having Ser. No. 60/280,240, entitled “Data Driven Entitlement,” filed Mar. 30, 2001—which is hereby incorporated by reference in its entirety.

### FIELD OF THE INVENTION

The present invention relates to an apparatus and method for providing Data Driven Entitlement to information that is being accessed by a Partner or end-user. In particular, the invention provides for Partner and User Entitlement, with a Partner being an entity such as a Buyer or Supplier, and a User being an end-user of the system and potentially belonging to a Partner organization.

### BACKGROUND OF THE INVENTION

Asera System.

The prior referenced applications provide for methods and apparatuses for creating custom configurable business or channel applications from a standardized set of components. More specifically, the referenced invention(s) allow each business to select from a set of applications, customize that set of applications, and/or develop new customized applications from a set of development components. The prior applications provide for a server based method wherein best-of-breed services and/or applications are integrated in a seamless fashion and offered to enterprise businesses which develop customized business service applications through using the system. The server device is previously (and hereafter) referred to as the Asera Commerce Server (ACS).

The ACS includes a Commerce Server that provides a core set of technology (or application) services. A unique architecture and framework are provided by the Commerce Server, which facilitates development and use of customized applications. Most interactions with external systems or Users are managed as Business Objects. The service application code is maintained separate from the data. This enables the system to quickly include (and/or change) new business processes or technology components without having to write substantial amounts of new code. The business result is more rapid customer deployments and/or modifications that are customized to include (if desired) the proprietary or competitive business practices of a contracting company.

The ACS can be viewed as a form of ASP (Application Service Provider). An ASP is generally an outsourcing business model. The ASP business model requires an open and extendable architecture that allows a system to implement a customer specific business solution in a short period of time. The ACS takes best-of-breed applications and incorporates them into one integrated solution to provide the ASPs. The architecture is scalable and extensible. A customized business (or channel) application solution is built for each enterprise company. The solution uses a “modular” or step-wise or “plug and play” approach towards building new applications. An enterprise company can then quickly acquire a turn-key e-commerce solution to automate their channel relationships. The system presents little (or no) risk for the enterprise company because a solution is built by the present system. The costs of undertaking such a development exist as a fixed development cost of the system. Any resulting customized solutions are implemented in considerably less time than previous systems. The enterprise company might pay for the application services on a cost per transaction, or a fixed fee basis.

The ACS is used to capture the particularized (or specific) business processes for a given customer, and these business processes are converted into a set of customized applications. The ACS uses business steps and rules to construct the application. The objects are data representations. The steps are business operations with a defined set of input and output ports, with each port also having a defined set of parameters. The business rules are used to capture customer specific business practices. A unique tool that employs a Graphical User Interface (GUI), allows a developer to arrange various steps (or composite steps) into business processes, or workflows. The tool provides library catalogs of steps to be applied to the various objects. The connections between steps are also verified as correct. A graphical display of the business process is shown, and rules can thereafter be applied to provide further customization by conditionally tagging certain points. Hence, to create a business process (or application) for any given business, tools are provided which allow modules (or steps) to be plugged or dropped into the potential process. The steps can be moved, or the connections modified. An initial person-to-person (or other type of) interview with the business (or customer) can be used to produce the framework for arranging the steps according to the needs of that particular business (i.e. customized routines). The modular aspect of the present system allows this to be done—and modifications made—in a relatively quick fashion. For instance, if a process has been created, but the customer wants it to behave in two different manners, then certain rules can be applied to provide the desired results, depending on conditional triggers that can be associated with the underlying Business Objects.

Entitlement.

Selective or controlled access to the data within the Asera (or any other) system is a key component for providing proper data security (and the like). Prior systems have provided limited access to data—in particular, columns of data—based upon User identity and such. However, such prior systems have not provided more selective access to data—in particular, individual rows of data.

The concept of Entitlement needs to provide a commerce system with the capability to grant a User authorization to a set of records, whereby only the User is entitled to access the records. Entitlement should be an integral part of applications running on the commerce system, and should be applicable for both Demand Chain (DC) customers as well as Net Market Maker (NMM) customers. The system should be sufficiently flexible to accommodate the varying nature of Net Market customers versus Demand Chain customers. In addition to Partner and User Entitlement, other Entitlements might also be addressed, such as User Administration (resources, roles, and access). Display filters might be provided to restrict or customize access to “columns,” or other such data fields to be displayed for an Asera customer. Entitlement for commerce applications (such as Catalog and Quote) might be used to primarily control the set of records (i.e. rows of data) being fetched, as opposed to columns of data (via, for instance, a display filter or the like).

Accordingly, what is generally needed in the field is an Entitlement method for controlled and selective access to data. The Entitlement method should provide selective access in terms of “rows” of data in a commerce application, access to discussion forums by subject area, and so forth. Entitlement should be provided on at least a Relationship, Partner, and User management level.

### SUMMARY OF THE INVENTION

Data Driven Entitlement (DDE) or simply Entitlement is a part of a security level that can be applied to a server which might provide various applications to a contacting User. Entitlement is a horizontal layer that services all of the applications in the Asera (or a comparable) suite. For instance, in Asera applications, security at the top-level is controlled by the User Administration (or User Admin) application, and access is granted through roles and resources. A resource represents objects that are accessed by the commerce server users. There are generally two kinds of resources: (1) Named Resources, which are predefined and are internal to the commerce server applications; and (2) Web Resources, which can be commerce server specific, or external to the commerce server. A role represents a subset of protected commerce server resources and external resources accessible via the commerce server. This role can then be assigned to a User. The User can access resources that are part of the assigned role.

Entitlement essentially provides the next level of security after User Admin. Entitlement controls the actual data that a User can access once the User has access to a particular application. For instance, two Users might have access to the same application, but depending on their positions in the organization, the Users might have access to different data. The fine-control over data that is accessible to a User is essentially controlled through Data Driven Entitlement. DDE also allows an organization to control what data or information it can publish or subscribe from other organizations.

Entitlement is based upon the concept of an application and its associated tasks. These are design time entities and are defined by the designer/developer of an application. They cannot generally be controlled by the activation. The only control such activation has is the decision to activate, or not to activate, Entitlement for an application.

Entitlement works on the paradigm that every task in the application allows a User to view or manipulate certain data. This data is the logical unit that is controlled by Entitlement. Entitlement allows a User (of a system so equipped) to control access to this data through some User-selected attribute of this data. Such Users might be Asera customers. For example, in an “Exchange” application, a customer might want to control the RFQs (Request for Quotation) through the RFQ attribute “Trade Category.” Values allowed might include “Boards” and “Chips.” In this case, Entitlement controls the “Trade Category” attribute in the Application/Task of Exchange/RFQ. The values that then act as the controlling agents are “Boards” and “Chips.”

In the Asera framework, Entitlement is a very controlled activity. By default, a User has no access to data. Instead, permissions to access data must be given explicitly. Publishers, in the context of any Application/Task, own the data. As such, these Publishers can control what data is accessible to which subscriber. Subscribers, by default, have no control over the data. However, once a Publisher grants access to its data, a Subscriber can then control what data it wishes to view. In addition, both Subscribers and Publishers can further control what data individual Users of their organizations can access through each Application/Task. The general default condition is that individual Users, whether belonging to the Publisher or Subscriber, have access to no data. Instead, they must be given explicit access to the data.

The entire mechanism of controlling data is done through “Profiles.” A Profile, in the context of Entitlement, is nothing but a condition in the context of an Application/Task. This condition can be applied to Partners or to Users. Profiles that are applicable to these Partners are called “Partner Profiles.” Profiles applicable to the Users are called “User Profiles.” A Partner Profile can be applied to all Partners, no Partners, trading Partners, or to selected Partners. A User Profile can be applied to all Users, no Users, roles, or to selected Users.

According to one aspect of the present invention, an apparatus for providing selective Entitlement to data being accessed by a Partner or an end-user of the system, the apparatus comprising: a user interface to collect and maintain certain entitlement information; a database to store to the entitlement information; a transformation generator to access the entitlement information and transform the entitlement data into conditions; an object cache onto which the conditions are loaded; an entitlement manager for selecting appropriate conditions from the object cache, and appending the conditions in a logical manner; and an access manager, used by at least one of the plurality of applications, to selectively provide access to a data source, whereby the access manager interacts with the entitlement manager to determine the conditions that have been fulfilled for data entitlement.

According to another aspect of the present invention, a method for providing selective Entitlement to data being shared between a plurality of applications configured for running on a system, the method comprising the steps of: creating a plurality of Partners associated with trading information on the system, whereby each Partner is identified as a buyer or seller; setting up certain Partner parameters; creating a Partner Profile for each Partner; creating a Relationship between each of the Partners; setting up a Relationship Profile; and using overlapping conditions in the Profiles to establishment entitlement to data from the plurality of applications.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a representative block diagram, according to one aspect of the present invention, showing the general Entitlement structure.

FIG. 2 is a representative block diagram, according to one aspect of the present invention, showing the interaction of Partners (Buyer and Supplier) and a User, all having overlapping Profile information.

FIG. 3 is a representative flow diagram, according to one aspect of the present invention, associated with creating and managing Entitlement information.

FIG. 4 is a representative block diagram, according to one aspect of the present invention, showing the Entitlement Relationship between Buyers and Sellers associated with an application, its attributes, and dynamic attribute rules.

FIG. 5 is a representative table, according to one aspect of the present invention, showing the selective setting of Entitlement Data values for an Application/Task (e.g., Catalog/Query).

FIG. 6 is a representative table, according to one aspect of the present invention, showing the resulting Conditions from the Entitlement Data.

FIG. 7 is a logical formulation of Entitlement, according to one aspect of the present invention, showing the logically arranged Conditions for an example Partner (i.e., Buyer 1).

FIG. 8 is a representative table, according to one aspect of the present invention, showing certain User Profile conditions associated with the Entitlement example.

FIG. 9(A) is a representative block diagram, according to one aspect of the present invention, showing another example Entitlement Relationship between Buyers and Sellers associated with an application and its attributes.

FIG. 9(B) is a representative table, according to one aspect of the present invention, showing the selective setting of Entitlement Data values for an Application/Task of FIG. 9(A).

FIG. 10(A) is a representative table, according to one aspect of the present invention, showing the resulting Conditions from the Entitlement Data of FIG. 9(B).

FIG. 10(B) is a logical formulation of Entitlement, according to one aspect of the present invention, showing the logically arranged Conditions for an example Partner (i.e., Buyer 1)

FIG. 11 is a representative block diagram, according to one aspect of the present invention, showing Data Entitlement Administration, Site Administration, and Partner Administration.

FIG. 12 is a representative flow chart, according to one aspect of the present invention, showing the creation of Partners, a Partner Relationship, and a Profile for the Relationship.

### DESCRIPTION OF THE PREFERRED EMBODIMENTS

Certain aspects of Entitlement will now be described in relation to the Asera Commerce System (ACS). The inventive principles associated with Entitlement are fully meant to be applied to other systems, but are described in relation to ACS for example purposes only. Entitlement is also described in terms of Partner Entitlement and User Entitlement, but is also meant to be applied to other groups or individuals, and their particularized access to certain data.

In relation to certain aspects described herein, the Entitlement application (or process) includes (at least) the following: (1) capturing Partner-to-Partner Profiles (Partner Entitlement) for access restrictions in terms of data and other activities. (2) Capturing access restrictions for users of the system within a Partner organization (User Entitlement). (3) Implementation of a mechanism for imposing access restrictions in a flexible manner. (4) Improving perceived trust in the overall system by Partner organizations because of Entitlement based security functionality.

In general, Entitlement is the capability of the commerce system (or the like) to grant a particular User authorized access to a set of records, whereby the User is thereby “entitled” to access those records. For example, in a Catalog application, when a User queries on product information, the User will be provided access to the list of products to which access has been granted, such as “hardware” products and not “software” products. The Entitlement application is envisioned to be a horizontal application and is used by many of Asera's applications. Structurally, Entitlement will include (a) Partner Entitlement, and (b) User Entitlement. Enforcement of Entitlement is based on a combination of a given application, a task, and the User performing the task.

Partner Entitlement allows management of trading Relationships between Partners (for example, buyers and sellers) of the system. The Entitlement pertains to the basic Relationship attributes, as well as the creation of Partner Profiles to specify preferences. These preferences might include access restrictions in the Catalog Application, for the Query task. Similarly, access restrictions might be applied to the Bid-Quote application, in relation to the RFQ task, or other such tasks. The Profiles are created by a Partner and assigned to them by other Partners. Since the Entitlement is at the Partner level, the Profiles apply to all Users of the impacted Partner organization.

Assignment of the associated attributes can be either static or dynamic. The process of defining static data on which a customer would like to base its data Entitlement is generally not UI (User Interface) driven. Implementation of such a UI would, however, be very straightforward. Without the UI, a consultation team can set up the data with the customer. This data primarily comprises the attributes in a business object and the values allowed on that attribute through which the customer wants to control the customer's data. Once defined, the attributes (if static) cannot generally be changed.

Dynamic attributes might also be used. An attribute in Entitlement corresponds to an attribute in a business object, the values of which are used to control the data access. An example of this is the Attribute related to “Trade Category” in an Exchange Application (i.e., goods to be Exchanged between parties). If a Buyer customer wants to set up the System so that it can send (for instance) RFQs for “Fabrication” to some Sellers, and “Pending” to others, then the attribute Trade Category should be set up as an Entitlement Attribute. The Entitlement values set for this attribute would be “Fabrication” and “Pending.” However, these values are static in nature.

In contrast, it is possible that there are times when the customer would like this value to be dynamically determined. The determination might be based on the identity (i.e. status, or access level) of the logged in User. This type of functionality can be handled by dynamic attributes. A dynamic attribute is handled identically as a static attribute in Profile creation and definition. The difference is encountered at the application time. When a dynamic attribute is used to control a User's data access, instead of providing a pre-defined set of values, a rule is invoked. This rule provides the values allowed for the User. Thus for each attribute defined as “dynamic,” a corresponding logic to determine the value is defined in the form of a rule.

User Entitlement allows for the creation of Entitlement Profiles by a Partner. These Profiles are assigned to one or more Users of that Partner organization. These Profiles apply in addition to any Partner Profiles applicable for that Partner Organization.

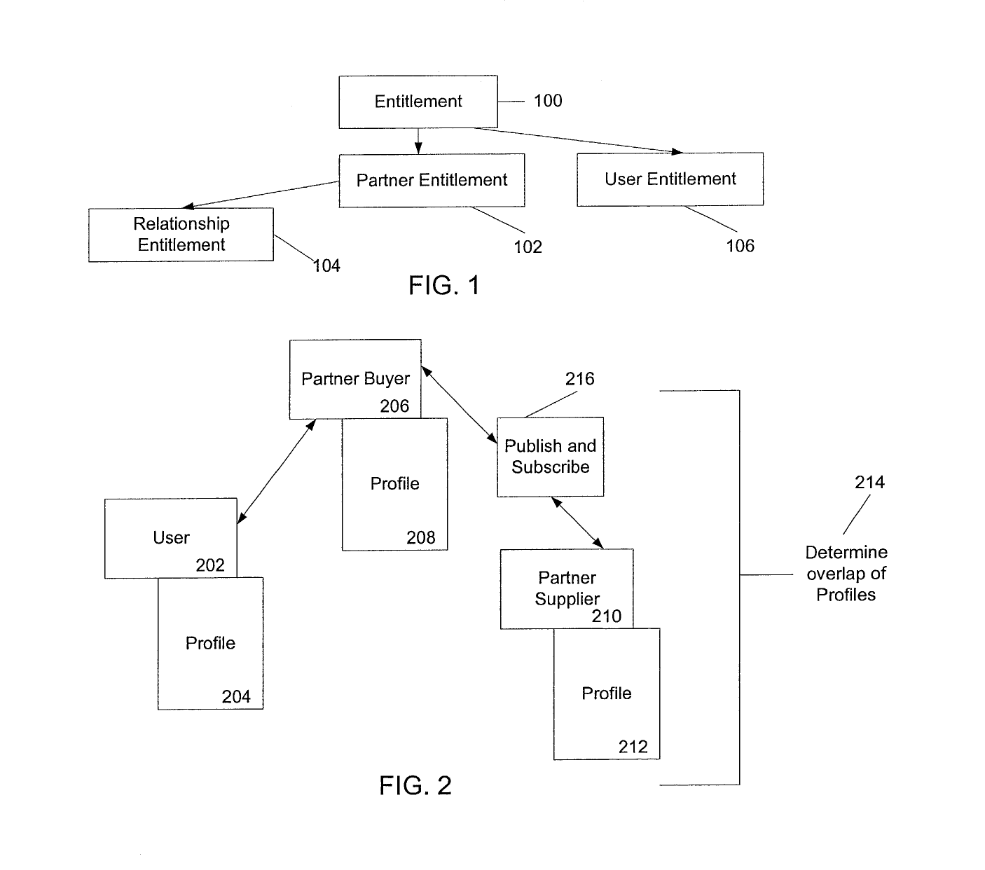

Referring to FIG. 1, certain representative components of the Entitlement process 100 are shown. Partner Entitlement 102 pertains to Entitlement within a Partner organization. Entitlement Profiles are assigned to Data Driven Entitlement User groups and Users. Relationship Entitlement 104 pertains to the Relationship between Partners. As such, Entitlement Profiles are assigned between Partners through a publish/subscribe mechanism. User Entitlement 106 is achieved by comparing the Entitlement Profiles of each User to those allowed by a Partner organization.

Entitlement provides for a system capable of granting a User only authorized (or entitled) access to records (or sets of records). The access may be in terms of “rows” of data in a commerce environment, or access to certain message boards, based upon such things as “theme names” in the community environment, and so forth. The need for Entitlement is generally at the Partner level and/or within a Partner organization level. The Entitlement Profiles at the Partner level for a given organization apply to all Users of the organization. The Entitlement Profiles at the User group or User level apply only to certain Users.

FIG. 2 next shows a representative example 200 of Entitlement being applied to three interacting parties. A User 202 is shown having a Profile 204, a Partner buyer 206 is shown having a Profile 208, and a Partner supplier 210 is shown having a Profile 212. Each of the parties can interact through the Asera commerce (or other such) system. Entitlement to any data associated with the parties is achieved by determining overlap in the Profiles (as shown by 214) as associated with the parties, and the Relationships between the parties. A publish and subscribe mechanism 216 is shown for assigning Entitlement Profiles between the representative Buyer Partner 206 and Supplier Partner 210.

The present system as applied to a Net Market customer will typically involve Users from the following entities: Net Market Maker (i.e., Asera customer), Sellers, Buyers, and Partners that may be both Sellers and Buyers. Individual Partners are restricted to data related to their own organization. For example, a Supplier might be restricted to the Supplier's own Catalog data, and a Buyer organization might only be allowed access the Buyer's own RFQ's, and not other Buyer organizations' RFQ's.

Within a Partner (Seller and Buyer) organization, different Users may have a need for data access restrictions such as sales representatives versus order entry clerks; sales representatives versus sales managers, and so forth. Certain restrictions would therefore be placed on what subset of company data, and what type of data, that a User can ultimately access. Examples of restrictions might include a determination as to what item groups, item categories, or item types that one User group can access versus other User groups.

In addition, since there are multiple sellers and buyers, there might also be trading Relationships that specify which buyers can buy from which sellers. As part of trading Relationships, Partners (buyers and sellers) may place access restrictions and preferences that will apply to all Users of the respective impacted Partner organization.

The present system as applied to Demand Chain customers will typically involve Users from the following entities: Seller (Asera customer), and Buyer. For Demand Chain customers, individual Partners might be restricted to data relating to their own organization. Moreover, within a Partner (i.e., Buyer and Seller) organization, different Users may have a need for data access restrictions such as sales representatives versus order entry clerks, sales representatives versus sales managers, and so forth. Restrictions might pertain to various subsets of company data, and the types of data that a User can access.

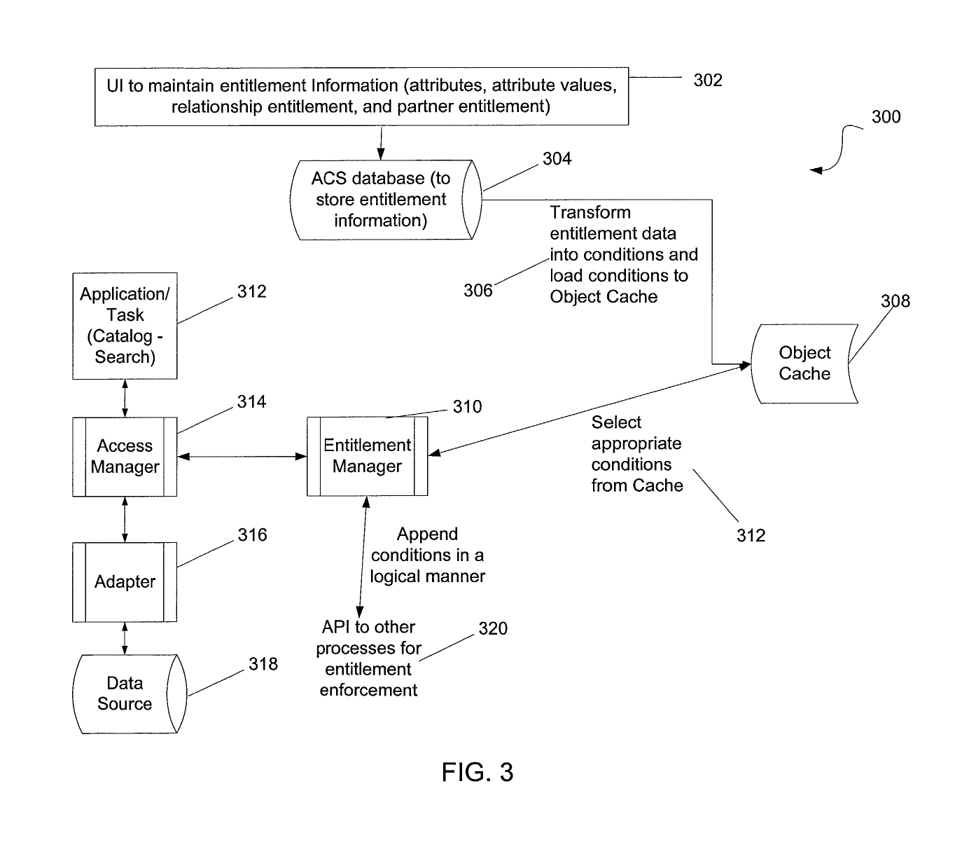

In relation to the above described data Entitlement Relationships, FIG. 3 shows a representative workflow 300 for Data Driven Entitlement. Process 302 shows a User Interface (UI) to maintain Entitlement information, including attributes, attribute values, Relationship Entitlement, Partner Entitlement, Profile creation and Profile maintenance. This UI interacts with an ACS database, which is used to store Entitlement information, and is shown as the direct data connector 304. The ACS is also sometimes referred to as a BCMS, or Business Commerce Management System. The flow arrow 306 next represents the transformation of Entitlement data into conditions and load conditions. These conditions and load conditions are stored in an Object Cache 308. Transformation might be accomplished via a transform generator, transform routine, or the like. An Entitlement Manager is shown as a predefined process 310. Flow arrow 312 represents the act of selecting appropriate conditions from the Object Cache 308. The Entitlement Manager 310 serves to append the conditions to the appropriate data in a logical manner. An Application/Task process 312 is shown to include the representative Catalog application, and Search task. The Application/Task 312 needs to access data from a direct data source 318. The Application/Task 312 calls a predefined process shown as Access Manager 314, which interacts with the Entitlement Manager. The Access Manager 314 thereafter calls the predefined process shown as Adapter 316 for interfacing with the Data Source 318. Data flow path 320 shows contacting an API (Application Interface) to other processes for Entitlement enforcement.

From a high-level perspective, two levels of Entitlement generally exist: Partner Entitlement and User Entitlement. Partner Entitlement includes NMM (Net Market Maker) Administration, which provides the following capabilities: (1) Manage Sellers and Buyers, including information related to these Partners; (2) Manage what applications/services the Buyers and Sellers can access; (3) Manage (i.e., create, delete, modify) the basic Relationship between Sellers and Buyers to allow trading between Partners; (4) Manage basic Relationship data such as contact information, payment terms, and so forth. Buyer and Seller Administration provides the following capabilities: (1) Manage basic Relationships and Relationship data, and (2) Manage Partner Profiles to provide access to preferences and/or restrictions. Under User Entitlement, with each Partner (NMM, Buyer, or Seller), further Entitlement restrictions can be placed at the User level, with User Profiles being created and assigned to the Users.

Enforcement of Entitlement will depend on a given application, task, and User combination. The implementation of Partner and User Entitlement will add restrictions to data accessible to a User. Additionally, the Entitlement process will provide APIs that can be called from other Asera applications which will provide the list of conditions in a standard XML format.

Certain assumptions are now presented, in light of an example to follow. The NMM or DC customer will define the Entitlement Attributes and values of these attributes that can be used for enforcing Entitlement. Partners can then use these attributes/values to define Relationship Entitlement and/or Partner Entitlement Profiles. According to implementation preferences, the Partners might be both Buyers and Sellers. Alternatively, the system can be configured so that Partners can only be Buyer or Sellers, and not both.

According to another assumption in order to be able to implement Partner Entitlement, the Partner ID for organizations should be in the object being fetched, or a related object. In the case of a Catalog Query, the “Product” object is being fetched. Accordingly, the Partner ID will be available as the Supplier ID. Similarly, for all applications, the Partner ID needs to be available, and may be the native attribute name representing Partner ID (for example Supplier ID).

Entitlement conditions will be returned in a pre-defined XML (Extensible Markup Language) format (in an accessible document), and the conditions will thereafter be applied in a format suitable for the respective application tasks. The Entitlement Process will provide for API's that can be called from other Asera applications which will provide the list of conditions in a standard XML format. In addition, those application tasks that involve ACS (or BCMS) staging tables can update the access document that is sent to the Access Manager process. For those applications that involve third party applications, the conditions can be stored/accessed in a format suitable for those applications.

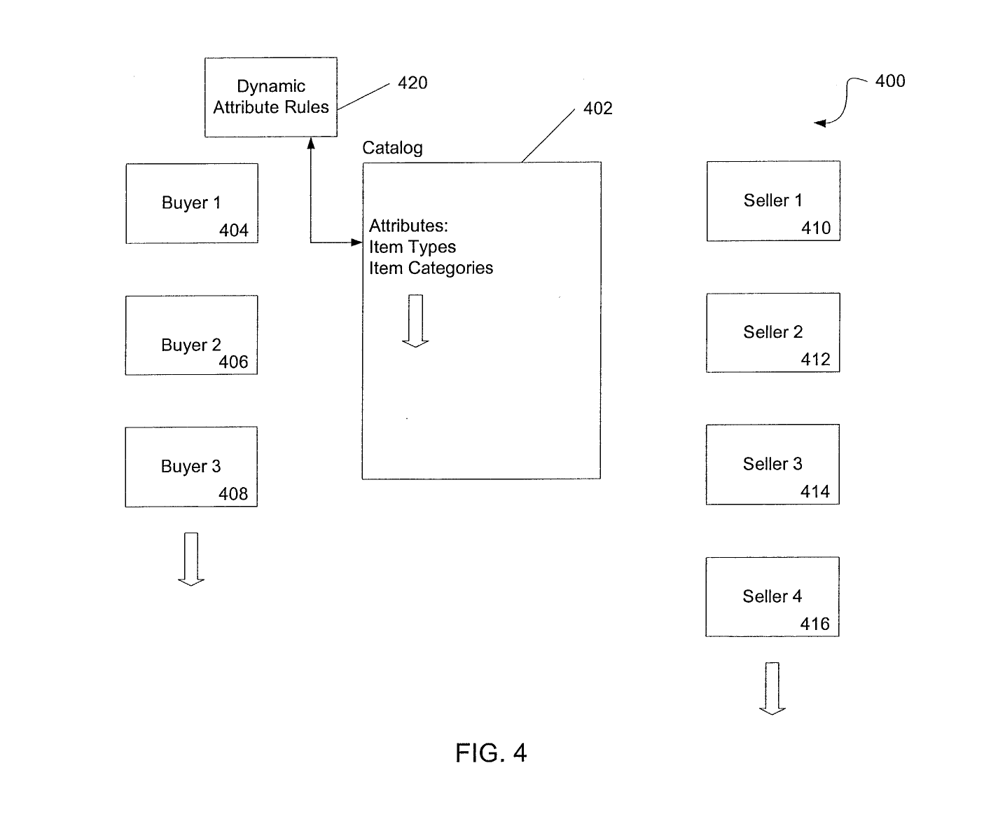

The following example will serve to demonstrate how a particular “Entitlement” to certain data is determined, depending upon the nature of the parties involved, and the setup of the attributes in their Profiles. FIG. 4 shows a Catalog/Query example 400, wherein the application is Catalog and the Task is Query. The Catalog 402 is shown to include Attributes, i.e., Item Types (i.e., 1, 2, 3, and so forth), Item Categories, and so forth. A set of Buyers, i.e. Buyer 1 (404), Buyer 2 (406), and Buyer 3 (408), and so forth, are shown to the left, and a set of Sellers, i.e. Seller 1 (410), Seller 2 (412), Seller 3 (414), and Seller 4 (416), and so forth, are shown on the right. The Attributes might be static and be set to a value, or dynamic and be assigned a value based upon the logic of corresponding rules 420 associated with each rule.

The Entitlement will be at the Partner level (Buyers and Sellers) and the User level (with the Buyer organization). Example Partner Level Entitlement data includes this relational setup: (1) Buyer (“B1”) subscribes to Item Types 1, 2, 3 from ALL Sellers (S1-S4); (2) S1 publishes access to B1 for Item type 1, 2; (3) S2 publishes access to Trading Partners (i.e., Buyers B1, B5, B7) for Item Type 1, 2; (4) S3 publishes access to Trading Partners (i.e., Buyers B1, B9, B12) for NO Items; (5) S4 publishes access to Trading Partners (Buyers B1, B5, B14) for ALL items.

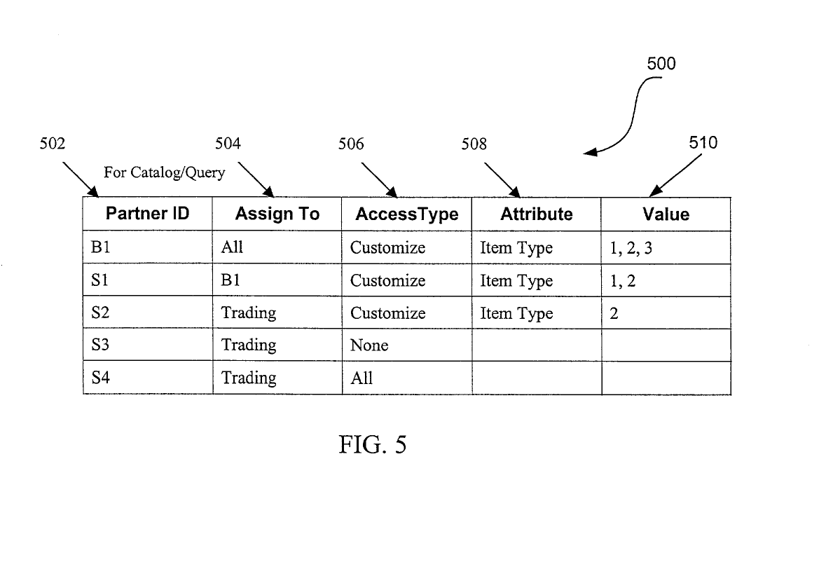

FIG. 5 shows a table 500 that summarizes the above Entitlement data. The columns include a “PartnerID” 502 being “Assigned To” 504 an “Access Type” 506. The particular “Attribute” 508 is listed, as are the assigned “Values” 510 that might exist for that Attribute. As such, the PartnerID B1 is assigned to “All” with the Access Type being “Customize.” The Attribute is “Item Type,” and B1 subscribes to all three types (1, 2, and 3).

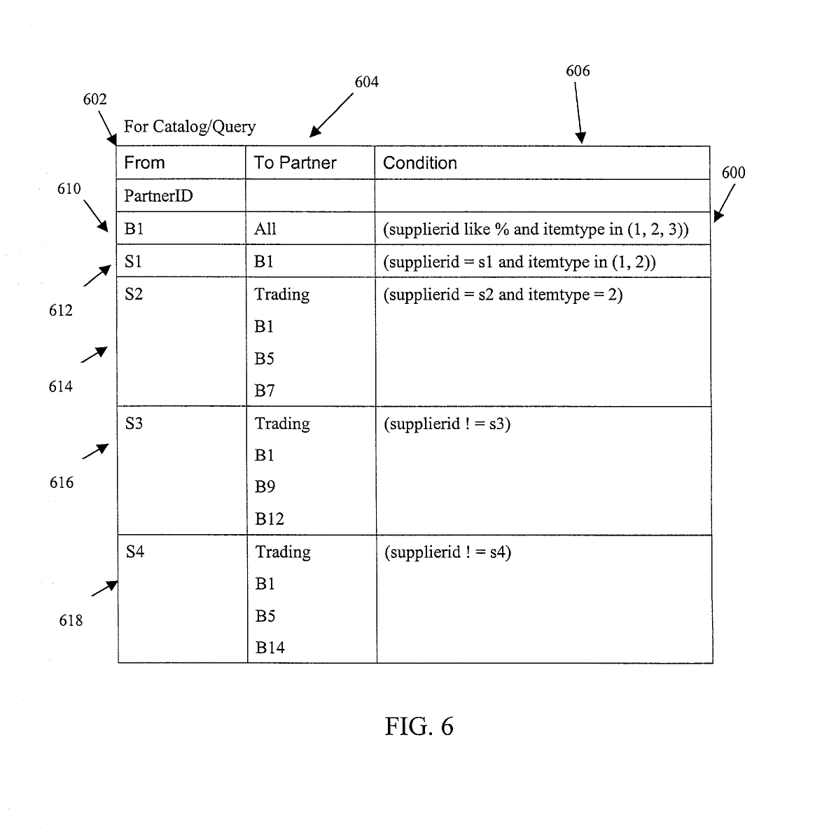

FIG. 6 next shows a table 600 of the associated “Conditions” that can be formulated from the Data Entitlement relations described above. The columns describe where the condition comes from (“From PartnerID” 602), and what other party is involved (“To Partner” 604). The Condition is then shown in column 606. In row 610, Data Entitlement is shown extending from the Partner identifier Buyer 1 to all other Partners. Since items types 1, 2, and 3 are subscribed to from all sellers, the condition can be described as: (supplierid like % and itemtype in (1,2,3)), wherein the % symbol is a default for all suppliers. In row 612, Data Entitlement is shown extending from Seller 1 to Buyer 1 for item types 1 and 2. The associated condition can be described as: (supplierid=s1 and itemtype in (1,2)). Row 614 shows Seller 2 extending data to Trading Partners, including Buyer 1, Buyer 5, and Buyer 7. The associated condition can be described as: (supplierid=s2 and itemtype=2). Row 616 shows Seller 3 extending data to Trading Partners, including Buyer 1, Buyer 9, and Buyer 12, with the condition being: (supplierid !=s3). Row 616 shows Seller S4 extending data to Trading Partners, including Buyer B1, Buyer B5, and Buyer B14, with the condition being: (supplierid =s4).

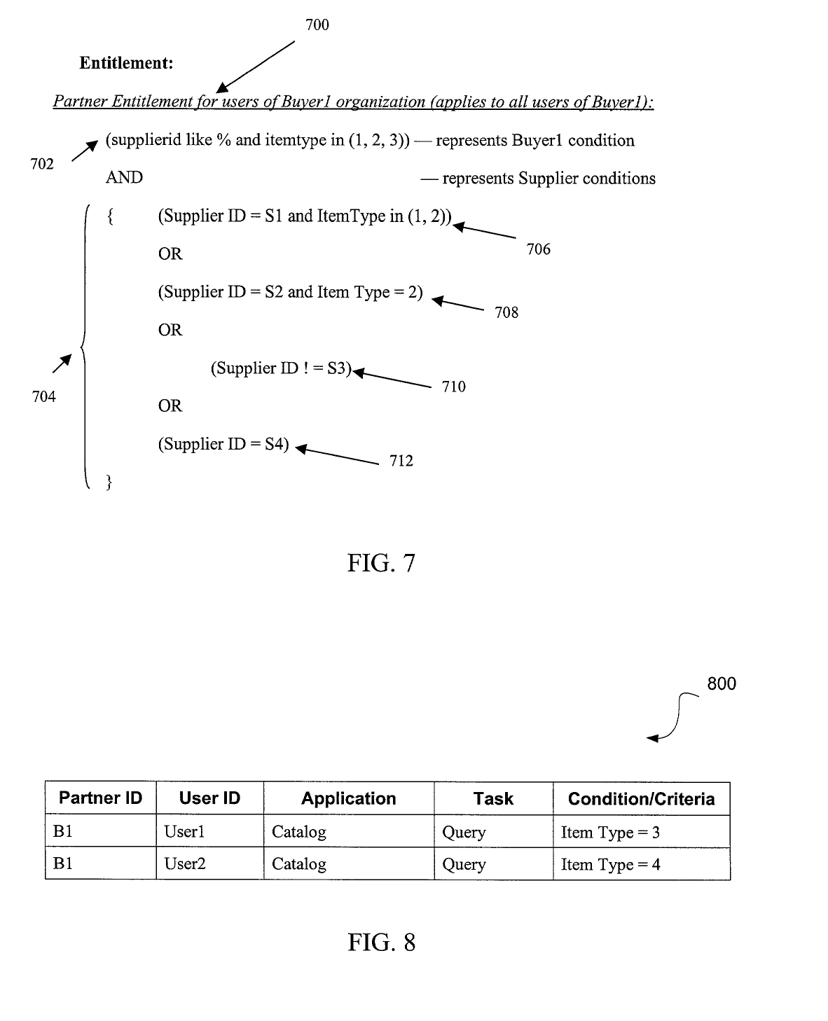

FIG. 7 next shows an example of Partner Entitlement 700 for Users of the Buyer 1 organization (which would apply to all Users of Buyer 1). The Partner Entitlement is based on the Profiles set up by the Buyer 1 organization and Seller organizations. This Data Entitlement is comprised of the Buyer 1 condition 702, and the four Supplier conditions (S1, S2, S3, and S4) 704. Since Buyer 1 (B1) has been assigned to all Sellers, then if the Buyer 1 condition 702 and any of the Seller conditions 706, 708, 710, or 712 are satisfied, then the overall Data Entitlement will occur for these overlapping set of conditions.

Another example of Data Entitlement is provided for Users of a Supplier organization (i.e., for all Users of Supplier 1 organization). In this instance, when Users of the Supplier 1 organization access the Catalog application, they should only be able to view their own organization catalog. This is achieved through a default Profile, which provides a condition: (Supplier ID=S1). This default Profile depends upon two factors: Partner type (supplier or buyer) and Application/Task (i.e., Catalog/Query, RFQ/Publish, etc.). Even for applying the default Profile, some form of Partner ID is needed (as detailed above). For example, for Catalog/Query, the default Profile is created for the Supplier. For Users of the Buyer organization, explicit Profiles are used (as illustrated above).

In addition to the Profiles described above, a Buyer 1 organization (or any other organization) might set up User Profiles. These User Profiles are internal Profiles affecting the Users of a particular organization. FIG. 8 shows an example table 800 of such User Profile conditions. These conditions will apply in conjunction with the Partner Entitlement conditions listed above. For User 1, Item Type 3 has been assigned, and for User 2, Item Type 4 has been assigned. These reflect the User level conditions when User 1 or User 2 logs onto the system.

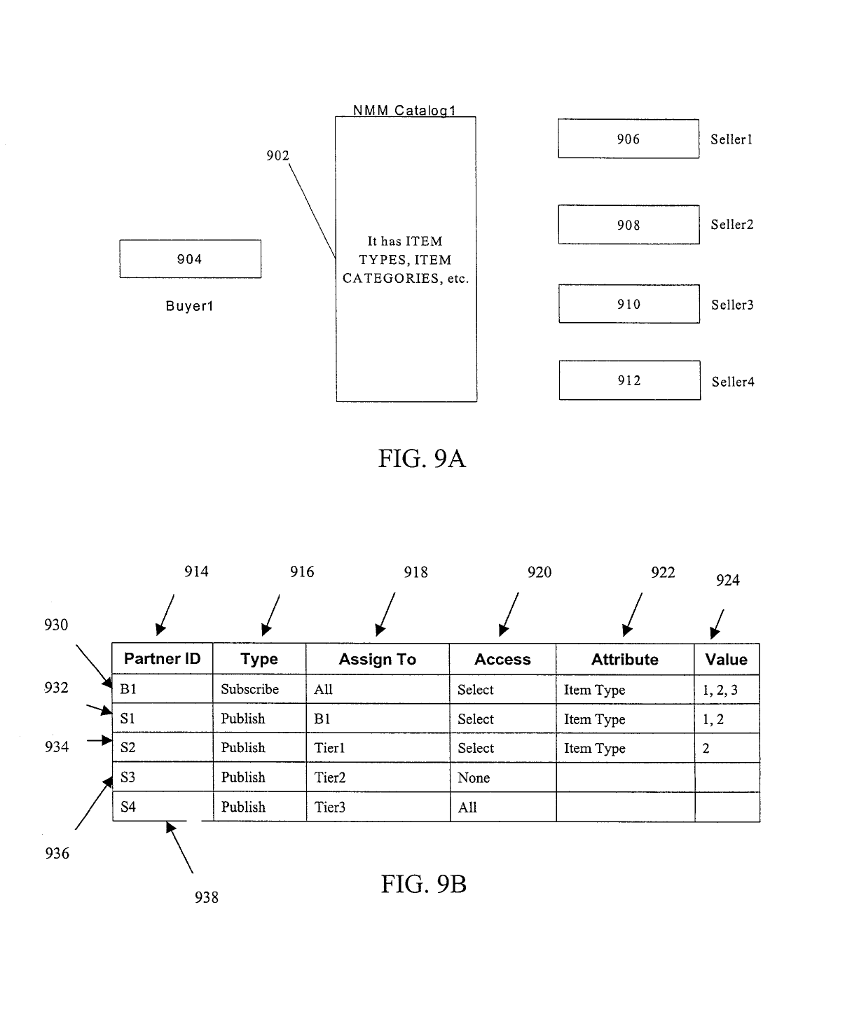

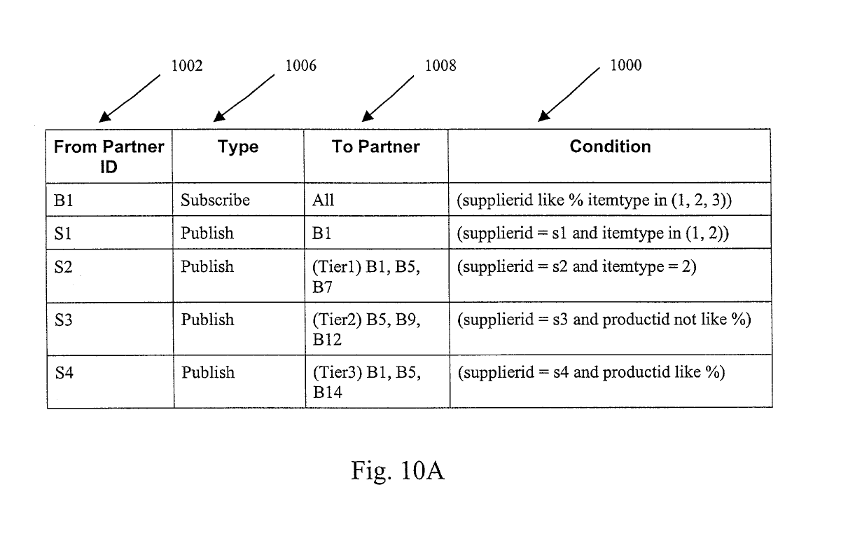

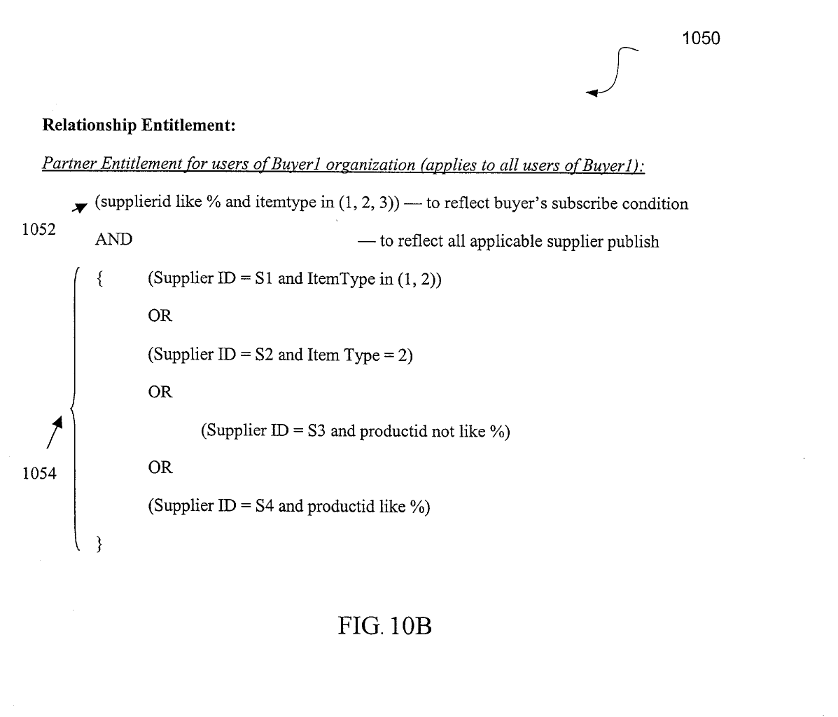

Still another example is provided in FIGS. 9(A), 9(B), 10(A), and 10(B). In FIG. 9(A), an NMM Catalog1 (902) is shown to have the attributes Item Types, Item Categories, and so forth. Buyer 1 (904) is shown on the left, with Sellers 1-4 (906-912) shown on the right. FIG. 9(B) shows a set of Entitlement Profile data, wherein the Partner ID is shown in column 914. In column 916, the Type is shown to include Subscribe or Publish, depending upon the Partner type. For instance, Buyers would generally tend to subscribe to data, whereas Sellers would generally tend to publish data. Column 918 shows other Partners to whom the data is assigned. Column 920 shows the type of access that is available for each identified Partner. Column 922 shows the selected Attribute being Item Type. Column 924 shows the value of the attribute for each identified Partner.

For row 930, the Partner ID is B1, and the Type is Subscribe. B1 has been assigned to all other Partners, with selective access. The Item Type is thereafter set to a value of 1, 2, or 3. Row 932 is for Partner ID of S1, with the Type being Publish. The data has been assigned to B1 with selective access, and the Item Type set to a value of 1 or 2. Row 934 is for Partner ID of S2, with the Type being Publish. The data has been assigned to Tier1 (i.e., Partners in a first tier), with selective access, and the Item Type set to a value of 2. Row 936 is for Partner ID of S3, with the Type being Publish. The data has been assigned to Tier2 (Partners in a second tier), with access being provided to no other Partners, and hence no attributes need to be selected. Row 938 is for Partner ID of S4, with the Type being Publish. The data has been assigned to Tier3 (Partners in a third tier), with access being provided to all other Partners, and hence the attributes do not need to be selected. The tiers can be defined as tiers of Partners/Users, and Entitlement Profiles are used to control access to these tiers.

FIG. 10(A) shows a table 1000, which includes the Condition (in column 1002) associated with each PartnerID. Column 1004 shows the Data Entitlement originating “from” the listed Partner ID, and column 1006 shows the resulting “to” Partner. Column 1008 shows the Data Entitlement Type, i.e. Subscribe or Publish for each identified Partner. Similar to the logic applied above in the previous example, the conditions are shown (in XML type format) as: For Partner ID=B1, the condition=(supplierid like % and itemtype in (1,2,3)); Partner ID=S1, condition=(supplierid=s1 and itemtype in (1,2)); Partner ID=S2, condition=(supplierid=s2 and itemtype=2); Partner ID=S3, condition=(supplierid=s3 and productid not like %); and Partner ID=S4, condition=(supplierid=s4 and productid like %).

FIG. 10(B) shows an example Relationship Entitlement 1050, as applicable for all Users of the Buyer 1 organization. The first part of Entitlement formula 1052 reflects the buyer's subscribe condition. The second part of the formula 1054 reflects the all the applicable supplier publish conditions. The two parts are joined by a logical AND, so that the Relationship Entitlement condition will be true if the Buyer's subscribe condition is true (as applicable to all Sellers), and any of the conditions for Seller 1, OR Seller 2, OR Seller 3, OR Seller 4 are true.

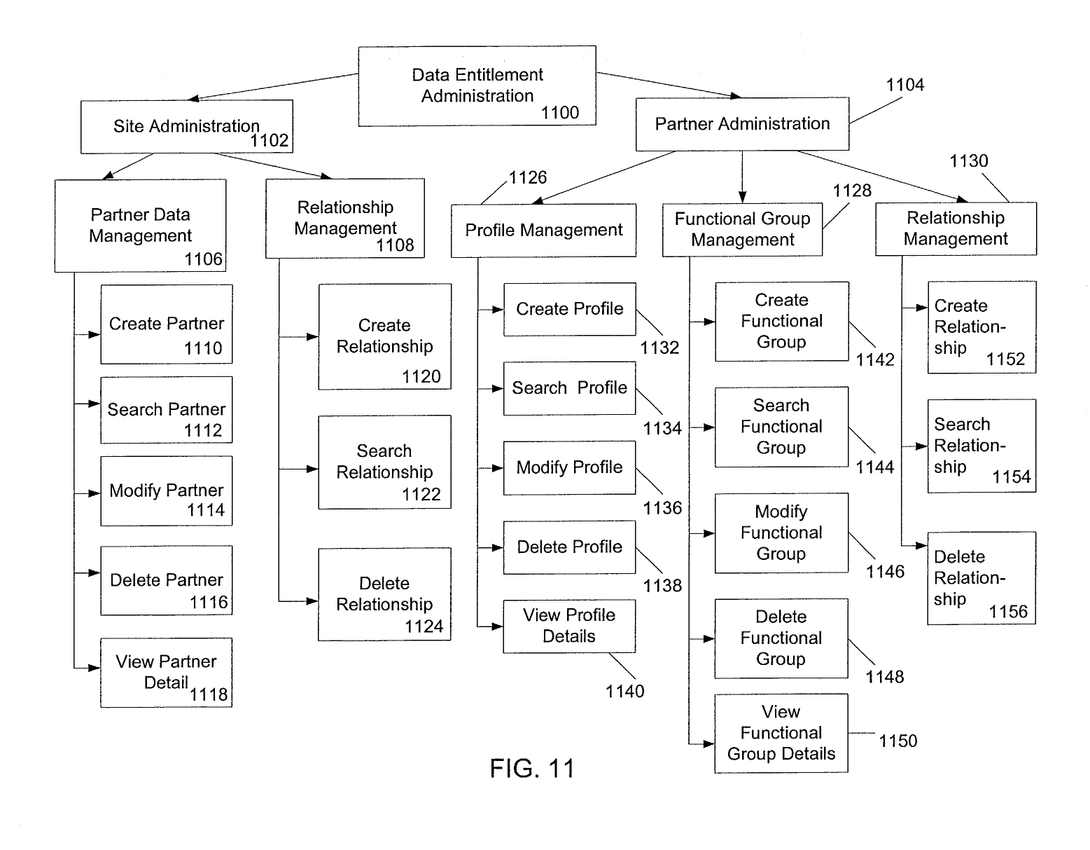

FIG. 11 further details certain applications and functionality associated with Data Entitlement Administration 1100. Primary applications include Site Administration 1102 and Partner Administration 1104. Note that either a Buyer or Seller is a Partner. In Demand Chain situations, any customer would be Partner. Regarding Relationships, in certain net markets, the buyers and sellers manage and maintain trading Relationships with each other. These are sometimes referred to as preferred vendors. Such Relationships involve discounts, payment terms, etc., and are created between a buyer and seller. Regarding Profiles, any Partner (Buyer and Seller) will have a Profile, which allows Users, or groups of Users, to have access to certain applications and services provided by the other group. This information is managed and maintained in the Profiles.

Partner Administration 1104 is shown to include Profile Management 1126, Functional Group Management 1128, and Relationship Management 1130. Profile Management includes representative functional components to: Create Profile (1132), Search Profile (1134), Modify Profile (1136), Delete Profile (1138), and View Profile Details (1140). Functional Group Management includes representative functional components to: Create Functional Group (1142), Search Functional Group (1144), Modify Functional Group (1146), Delete Functional Group (1148), and View Functional Group Details (1150). Relationship Management includes representative functional components to: Create Relationship (1152), Search Relationship (1154), and Delete Relationship (1156).

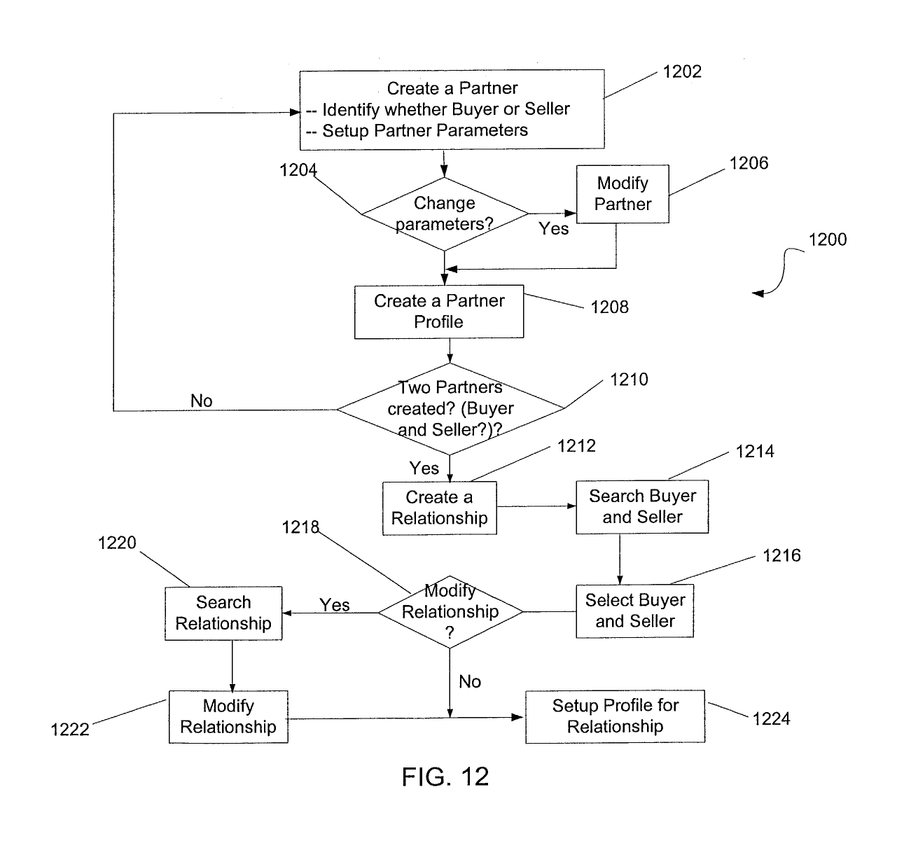

FIG. 12 next shows a flowchart 1200 of certain representative steps that should be taken to set up the Partner Relationship, and then administer and manage the Relationship. Step 1202 provides for creating a Partner, whereby the Partner is identified as a Buyer or Seller. The creation process also includes setting up the Partner parameters (such as discount codes, and the like). The fields in the Partner Parameters are generally configurable. Decision block 1204 next inquires whether certain parameters need to be changed. If yes, then step 1206 provides for modification of the Partner (and associated parameters).

Step 1208 next provides for creation of a Partner Profile. A Relationship can next be established, provided that two or more Partners have been created. Decision block 1210 inquires whether these two Partners exist, i.e., a Buyer and Seller. If No, then control returns to step 1202 to create another Partner.

Once a sufficient number of Partners exists, then step 1212 provides for creating a Relationship between the Partners. Setting up the Relationship is generally facilitated by using a routine 1214 to search for the Buyer and the Seller in the database. Various results might be provided, and an appropriate Buyer and Seller must be selected for creation of a Relationship. Once the Relationship has been created, it is searchable so that necessary changes might be made. Decision block 1218 inquires whether the Relationship should be modified. If Yes, then step 1220 provides for searching the Relationship, and step 1222 provides for modifying the Relationship.

Step 1224 finally provides for selecting a particular Relationship and setting up a Profile for that Relationship. This Relationship will thereby allow for access to specific sets of Applications.

1. An apparatus for providing selective entitlement to data being accessed by a partner or an end-user of the system the apparatus comprising:
a user interface to collect and maintain certain entitlement information;
a database to store to the entitlement information;
a transformation generator to access the entitlement information and transform the entitlement data into conditions;
an object cache onto which the conditions are loaded;
an entitlement manager for selecting appropriate conditions from the object cache, and appending the conditions in a logical manner; and
an access manager, used by at least one of the plurality of applications, to selectively provide access to a data source, whereby the access manager interacts with the entitlement manager to determine the conditions that have been fulfilled for data entitlement.

2. The apparatus of claim 1, wherein the certain entitlement information includes at least entitlement attributes, entitlement attribute values, relationship entitlement information, and partner entitlement information.

3. The apparatus of claim 1, wherein an adapter routine is provided between the access manager and the data source to facilitate proper access between different formats.

4. The apparatus of claim 1, wherein partners are created in association with using the sharing entitlement data.

5. The apparatus of claim 4, wherein the partners including buyers and sellers.

6. The apparatus of claim 4, wherein a profile is created for each partner.

7. The apparatus of claim 6, wherein a relationship is created between partners, and a relationship profile is set up.

8. A method for providing selective entitlement to data being shared between a plurality of applications configured for running on a system, the method comprising the steps of:
creating a plurality of partners associated with trading information on the system, whereby each partner is identified as a buyer or seller;
setting up certain partner parameters;
creating a partner profile for each partner;
creating a relationship between each of the partners;
setting up a relationship profile; and
using overlapping conditions in the profiles to establishment entitlement to data from the plurality of applications.

9. The method of claim 8, wherein the data entitlement is established from a publisher of certain data to a subscriber of certain data.

10. A method for providing selective entitlement to data being shared between a plurality of applications configured for running on a system, the method comprising the steps of:
providing a user interface to collect and maintain entitlement information pertaining to partners and users of the system;
storing the entitlement information on a system database;
transforming the entitlement data into conditions;
loading the conditions onto an object cache;
providing an entitlement manager for selecting appropriate conditions from the object cache; and
providing an access manager, as utilized by the applications, wherein the access manager calls the entitlement manager to provide entitlement to data stored and fetched from a data source.

11. The method of claim 10, wherein the entitlement manager appends the conditions in a logical manner to establish data entitlement based upon the whole set of conditions.

12. The method of claim 11, wherein the conditions are stored and retrieved in an XML format.

13. The method of claim 10, wherein the access manager calls the entitlement manager before fetching the data.

14. The method of claim 13, wherein the steps include:
providing the entitlement manager with an original search condition and having the entitlement manager return a modified search condition;
fetching a data result, via a database adapter, based upon the modified condition.

15. The method of claim 10, wherein the access manager calls the entitlement manager after fetching the data.

16. The method of claim 15, wherein the steps include:
fetching an original data result, via a database adapter, based upon an original search condition;
providing the entitlement manager with the original data result plus certain entitlement arguments and having the entitlement manager return a modified result.
